(19) United States
(12) Patent Application Publication
(10) Pub. No.: US 2010/0019037 A1
(43) Pub. Date: Jan. 28, 2010

(54) METHOD AND SYSTEM FOR DYNAMICALLY MANAGING REMOVABLE DEVICE

(76) Inventors: Chih-Wei Lai, Hsinchu County (TW); Kuen-Bin Lai, Hsin-Chu City (TW); Chi-Tai Wu, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/365,899

(22) Filed: Feb. 5, 2009

(30) Foreign Application Priority Data
Jul. 24, 2008 (TW) 097128110

(51) Int. Cl. G06K 7/01

(52) U.S. Cl. 235/435

(57) ABSTRACT

A method for dynamically managing a removable device includes the following steps: generating a device insertion interrupt to indicate that the removable device has been coupled to a connection interface when detecting an insert event corresponding to the removable device; clearing the device insertion interrupt before a processing mechanism corresponding to the connection interface handles the device insertion interrupt; and identifying a specification of the removable device to dynamically manage the removable device according to the specification; wherein when the specification corresponds to a first specification, a first management scheme is activated to manage the removable device, when the specification corresponds to a second specification, a second management scheme is activated to manage the removable device, and the first specification is different from the second specification.

### BACKGROUND OF THE INVENTION

1. Field of the Invention

The present invention relates to device management, and more particularly, to a method and system capable of managing a Secure Digital (SD) card and a Secure Digital I/O (SDIO) card via automatically activating one peripheral component interconnect (PCI) device function corresponding to the SD card when the inserted device is an SD card, or automatically activating another function on the same peripheral component interconnect (PCI) device corresponding to the SDIO card when the inserted card is an SDIO card.

2. Description of the Prior Art

As is well-known to people skilled in the art, a PCI device has a bus number, a device number and a function number, and a common PCI system can, at most, connect to 256 buses; each bus being allowed to connect with 32 devices, and each device having no more than 8 functions.

For a multi-function card reader that complies with a plurality of different specifications (e.g., a multi-function card reader for memory cards corresponding to a secure digital (SD) specification, a MultiMediaCard (MMC) specification, a memory stick (MS) specification, or an extreme digital (xD) picture specification), a system will enumerate different host controllers corresponding to the SD specification, the MMC specification, the MS specification and the xD specification, respectively, when the said multi-function card reader is coupled to a system bus (e.g., PCI or PCI Express bus). After the host controllers are enumerated, the system will load a plurality of drivers respectively corresponding to the supportive specifications, such as the driver corresponding to the SD specification, the driver corresponding to the MMC specification, the driver corresponding to the MS specification, and the driver corresponding to the xD specification.

For the above system, each function number of an interconnected device is viewed as a single device. In other words, when an SD card is inserted into the said common multi-function card reader, only the SD host controller will be used to manage the inserted SD card. Similarly, only the MMC host controller is activated to manage the inserted device when the inserted device complies with the MMC specification; only the MS host controller is activated to manage the inserted device when the inserted device complies with the MS specification, and a similar relation exists between the inserted device and the xD host controller when the inserted device is an xD picture card.

The most multi-function card readers are free from providing a specified SD driver corresponding to the multi-function card reader since a modern operating system can support the SD host controller directly. Therefore, when an SD card or an SDIO card is inserted into a multi-function card reader, the operating system will activate a native SD bus driver built inside the operating system for managing the SD card or the SDIO card.

Please refer to FIG. 1. FIG. 1 is a diagram illustrating a flow chart when a prior art SD card 110 is inserted into a multi-function card reader. As shown in FIG. 1, the system loads a native SD driver 130—a native SD bus driver (sdbus.sys)—provided by the operating system when the computer system enumerates a SD host controller 120 after the multi-function card reader be connected to system bus. The native SD bus driver 130 then informs the operating system of the computer system to load demanded SD drivers (e.g., a native SFF storage driver 140) according to the specification of the inserted SD device after the user inserts the SD device (e.g., SD card 110) into the multi-function card reader. For instance, the operating system loads a native SD storage class driver (sffdisk.sys) and a storage miniport driver (Sffp_sd.sys) to manage the inserted SD card via using the SD bus library 142.

Please refer to FIG. 2. FIG. 2 is a diagram illustrating a flow chart when a prior art SDIO card 210 is inserted into the multi-function card reader. As shown in FIG. 2, when the user inserts a SDIO card 210 (e.g., a GPS receiver or a wireless LAN card configured with an SDIO interface) into the multi-function card reader, the SD host controller 220 at this time informs the operating system to load the non-native SDIO driver provided by the device manufacturers to manage the inserted SDIO card 210. That is, while managing the SDIO card 210, a non-native driver provided by the device manufacturer is demanded other than the native SD bus driver 230. As shown in FIG. 2, a non-native SDIO device driver 240 (Third Party SDIO device driver) must be loaded to manage the SDIO card 210 besides the native SD bus driver 230 built inside the operating system.

However, using the native SD driver built inside the operating system to manage the inserted SD card will restricted the use of latest SD card specification. For example, Windows XP did not support for Secure Digital High Capacity (SDHC) cards that have a capacity of more than 4 gigabyte (GB). User who buys the SDHC cards has to install Windows Vista to their NB or PC for use the SDHC cards properly.

Moreover, using the native SD driver built inside the operating system to manage the inserted SD card will restricted the use of high speed (class 6) SD card specification. For example, user who buys high speed (class 6) SD cards the accessing performance is restricted by a conventional management mechanism which provided by native SD driver. By fine tune the control mechanism, user can get 20% improve on accessing performance.

In addition, as various SDIO cards are currently provided, the stability and compatibility should be concerned firstly. Thus, it is necessary to manage these SDIO cards via the native driver built inside the operating system.

There is therefore a demand for providing a novel management scheme to solve the disadvantages of a conventional management scheme while retaining the advantages of the prior art to manage an SDIO card via the native driver built inside the operating system, thereby providing users with a better usage environment.

### SUMMARY OF THE INVENTION

It is one of the objectives of the present invention to provide a method and system capable of managing a Secure Digital (SD) card and Secure Digital I/O (SDIO) card via automatically activating one peripheral component interconnect (PCI) device function corresponding to the SD card when the inserted device is an SD card, and automatically activating another function of the same peripheral component interconnect (PCI) device corresponding to the SDIO card when the inserted card is an SDIO card, so as to solve the problems of the prior art.

In accordance with an embodiment of the present invention, a method for dynamically managing a removable device is provided. The method for dynamically managing the removable device includes the following steps: generating a device insertion interrupt to indicate that the removable device has been coupled to a connection interface when detecting an insert event corresponding to the removable device; clearing the device insertion interrupt before a processing mechanism corresponding to the connection interface handling the device insertion interrupt; and identifying a specification of the removable device to dynamically manage the removable device according to the specification; wherein when the specification corresponds to a first specification, a first management scheme is activated to manage the removable device; when the specification corresponds to a second specification, a second management scheme is activated to manage the removable device, wherein the first specification is different from the second specification.

In accordance with another embodiment of the present invention, a system (e.g., a framework) for dynamically managing a removable device is provided. The system (e.g., a framework) for dynamically managing the removable device includes a SD host controller and a host device (e.g., Personal Computer). The SD host controller is utilized for generating a device insertion interrupt to indicate that the removable device has coupled to a connection interface of the SD host controller when the SD host controller detects an insert event corresponding to the removable device. The host device coupled to the SD host controller is utilized for receiving the device insertion interrupt. And the SD host controller clearing the device insertion interrupt before a processing mechanism corresponding to the connection interface handling the device insertion interrupt, and for identifying a specification of the removable device to thereby dynamically manage the removable device according to the specification; wherein when the specification of the removable device corresponds to a first specification, the host device activates a first management scheme to manage the removable device, and when the specification of the removable corresponds to a second specification, the host device activates a second management scheme to manage the removable device, wherein the first specification is different from the second specification.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a flow chart when a prior art SD card is inserted into a multi-function card reader.

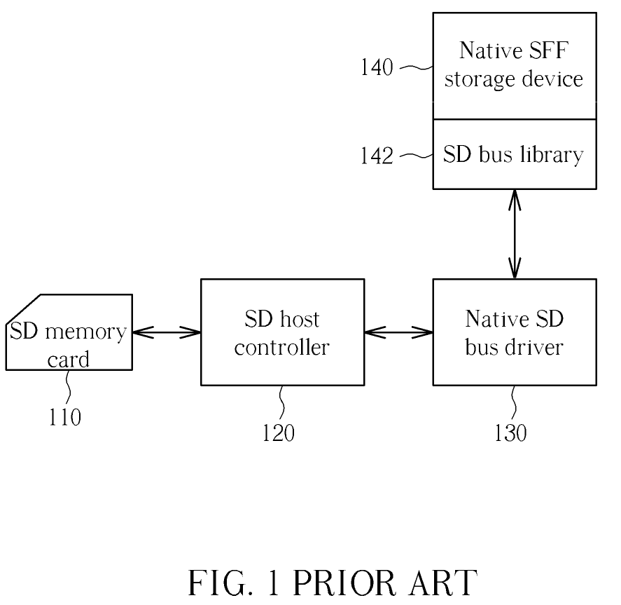

FIG. 2 is a diagram illustrating a flow chart when a prior art SDIO card is inserted into the multi-function card reader.

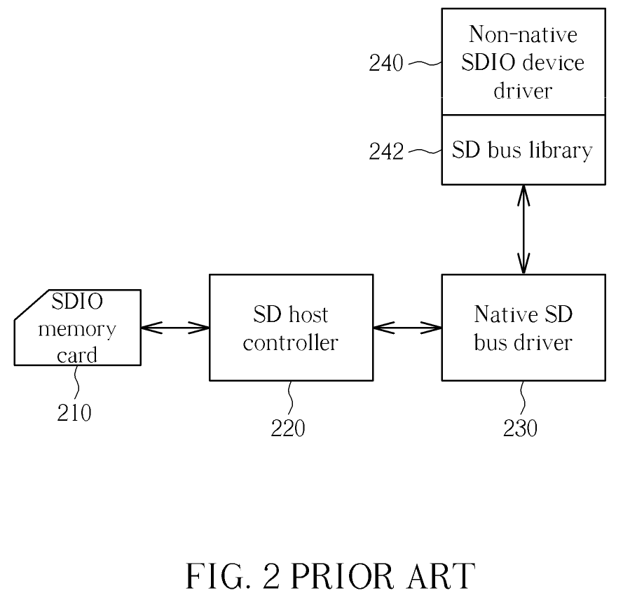

FIG. 3 is a diagram illustrating an exemplary embodiment of a management system of the present invention for managing an SD card and the SDIO card.

FIG. 4 is a flowchart illustrating an exemplary embodiment of the method for dynamically managing the removable device (SD card and/or SDIO card) via the management system illustrated in FIG. 3.

FIG. 5 is a flowchart illustrating an exemplary embodiment of the method for dynamically managing the removable device when an SD card is inserted.

FIG. 6 is a flowchart illustrating an exemplary embodiment of the method for dynamically managing the removable device when an SDIO card is inserted.

### DETAILED DESCRIPTION

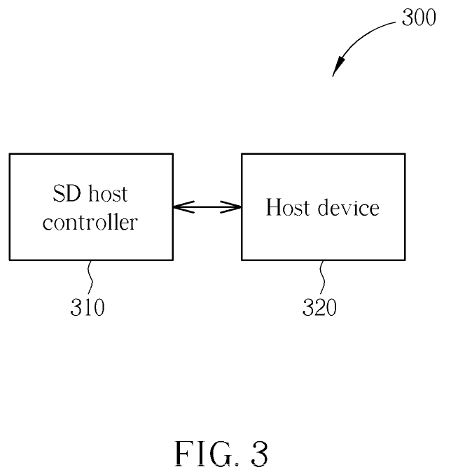

Please refer to FIG. 3. FIG. 3 is a diagram illustrating an exemplary embodiment of a management system 300 of the present invention for managing the SD card and the SDIO card. As shown in FIG. 3, the management system 300 includes (but is not limited to) a SD host controller 310 and a host device 320 (e.g., a personal computer). The SD host controller 310 controls the accessing operations of an inserted device (e.g., an inserted memory card) according to the specification that the inserted device complies with. For instance, in this embodiment the host device 320 is implemented by a personal computer which contains the drivers corresponding to the removable devices (e.g., the SD card and the SDIO card). However, this is for illustrative purposes only and is not meant to be a limitation of the present invention. In addition, the configuration of the management system 300 illustrated in FIG. 3 is for illustrative purposes only; alternative configurations of the management system also obey the spirit and fall within the scope of the present invention.

For instance, in another embodiment of the present invention, the host device 320 is a personal computer while the SD host controller 310 at this time is arranged in an external card reader. In addition, in another embodiment of the present invention, the SD host controller 310 and the host device 320 are integrated into one personal computer, and this alternative designs also falls within the scope of the present invention. The detailed descriptions of the disclosed method of the present invention for dynamically managing the inserted SD card and/or the inserted SDIO card are described as follows.

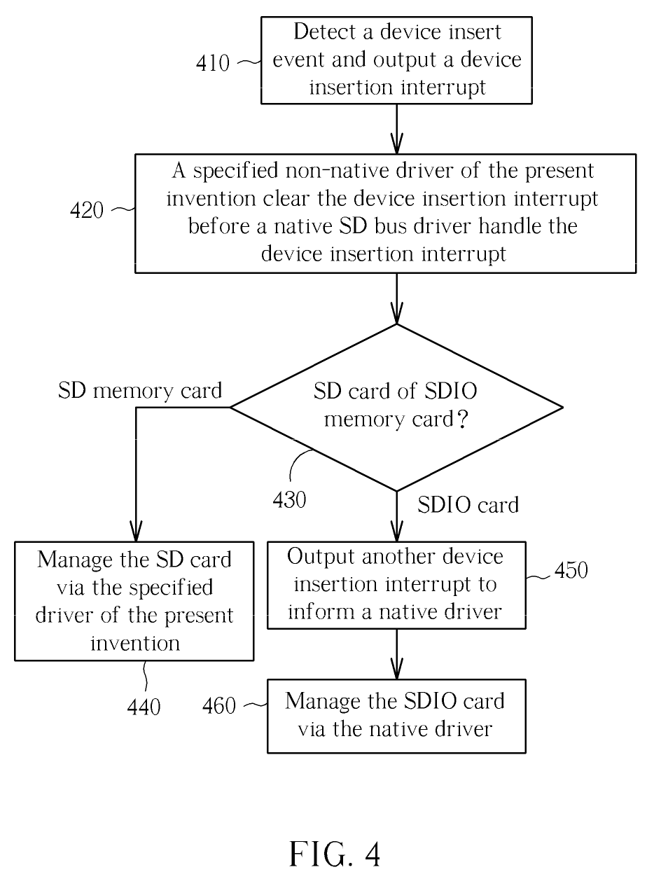

Please refer to FIG. 4 in conjunction with FIG. 3. FIG. 4 is a flowchart illustrating an exemplary embodiment of the method for dynamically managing the removable device (SD card and/or SDIO card) via the management system 300 illustrated in FIG. 3. Please note that if the result is substantially the same, the steps are not limited to be executed according to the exact order shown in FIG. 4. The flow includes the following steps:

Step 410: Output a device insertion interrupt (i.e., a card insert interrupt) after detecting a device insertion event corresponding to the SD card or corresponding to the SDIO card;

Step 420: Utilize a specified non-native driver provided of the present invention to clear the device insertion interrupt (i.e., card insert interrupt) before a native SD bus driver handles the device insertion interrupt (card insert interrupt);

Step 430: Utilize the specified non-native driver of the present invention to identify whether the specification of the inserted device corresponds to the SD specification of an SD card, or to the SDIO specification of a SDIO card;

Step 440: Manage the inserted SD card via the specified non-native driver of the present invention;

Step 450: Output a new device insertion interrupt (another card insert interrupt) to inform a native driver (e.g., the native SD bus driver);

Step 460: Manage the SDIO card via the native driver (the native SD bus driver).

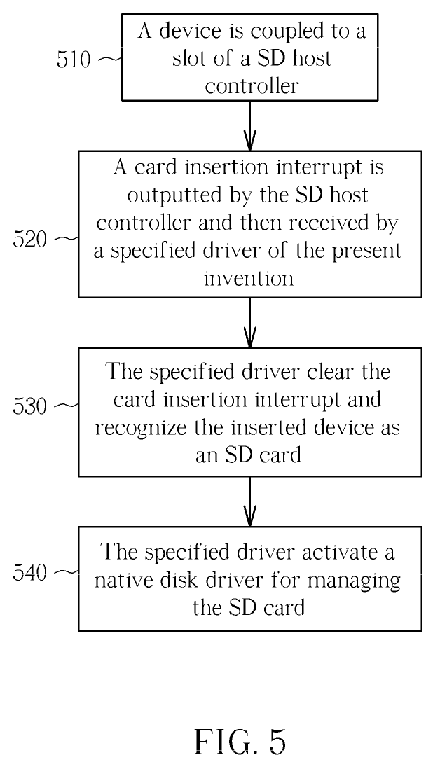

The detailed descriptions of the management method when the inserted device is an SD card are described as follows. Please refer to FIG. 5 in conjunction with FIG. 3 and FIG. 4. FIG. 5 is a flowchart illustrating an exemplary embodiment of the method for dynamically managing the removable device when an SD card is inserted. Please note that if the result is substantially the same, the steps are not limited to be executed according to the exact order shown in FIG. 5. The flow includes the following steps:

Step 510: Couple a device to a slot of the SD host controller 310 (i.e., a device is coupled to an SD slot of the SD host controller 310);

Step 520: Utilize the SD host controller 310 to output a card insert interrupt; the card insert interrupt is then received by the specified non-native driver of the present invention;

Step 530: Utilize the specified non-native driver of the present invention to clear the card insert interrupt and then recognize that the inserted device is an SD card;

Step 540: Utilize the specified non-native driver of the present invention to activate another native disk driver for managing the accessing operations of the inserted SD card.

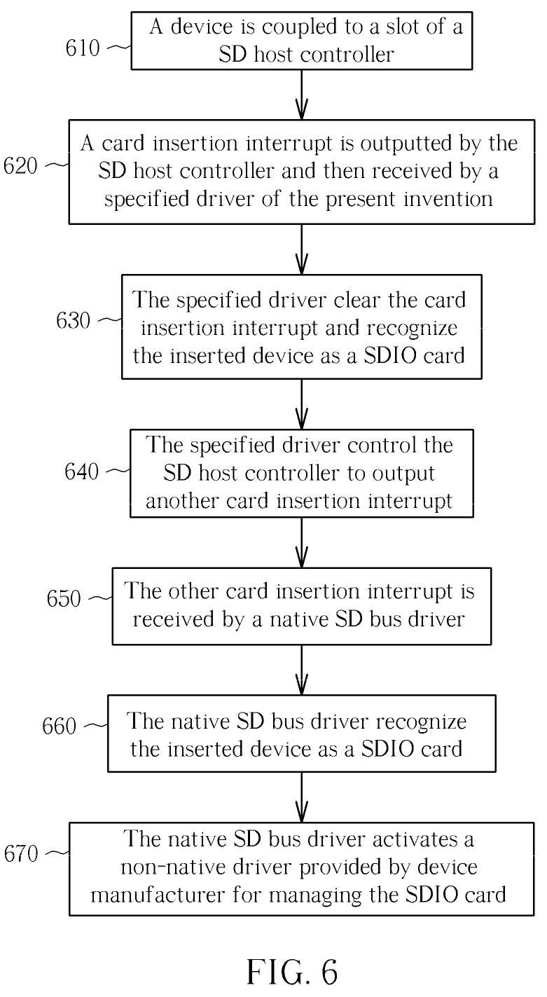

In addition, the detailed descriptions of the management method when the inserted device is an SDIO card are described as follows. Please refer to FIG. 6 in conjunction with FIG. 3 and FIG. 4. FIG. 6 is a flowchart illustrating an exemplary embodiment of the method for dynamically managing the removable device when an SDIO card is inserted. Please note that if the result is substantially the same, the steps are not limited to be executed according to the exact order shown in FIG. 6. The flow includes the following steps:

Step 610: Couple a device to a slot of the SD host controller 310 (a SD slot);

Step 620: Utilize the SD host controller 310 to output a card insert interrupt, the card insert interrupt is then received by the specified non-native driver of the present invention;

Step 630: Utilize the specified non-native driver to clear the card insert interrupt and then identify the inserted device as an SDIO card;

Step 640: Utilize the specified non-native driver of the present invention to control the SD host controller 310 to output a new card insert interrupt;

Step 650: Successfully receive the new card insert interrupt via a native SD bus driver;

Step 660: Utilize the native SD bus driver to identify the specification of the inserted device, and thereby recognize the inserted device is an SDIO card;

Step 670: Utilize the native SD bus driver to activate a non-native driver which is provided by device manufacturer for managing the accessing operations of the inserted SDIO card.

From the aforementioned disclosure, it is clear that a critical idea of the present invention is to provide a specified non-native driver to manage the inserted device via the cooperation of the specified non-native driver and the SD host controller 310, thereby improving the accessing speed whiling reading a high speed SD card and solving the problem of the conventional management mechanism.

Furthermore, in alternative embodiments of the present invention the host device 320 is a notebook and the power consumption of the notebook is reduced since the usage of the specified non-native driver, thereby promoting the allowed standby time of the notebook via the disclosed management mechanism including the specified non-native driver wherein the specified non-native driver can provide the user with more functions (e.g., a D3 State Enhancement (D3E TM) function).

When the inserted device is an SDIO card complying with an SDIO specification, the disclosed method and system still activates the native SD bus driver built inside the operating system to manage the inserted SDIO card, thereby achieving excellent stability and compatibility and avoiding hardware conflicts.

In conclusion, the management method and system of the present invention provides a specified non-native driver to manage an inserted SDIO card and/or SD card to solve the problems of the convention management mechanism. It should be noted that the aforementioned descriptions are for illustrative purposes only and are not meant to be limitations of the present invention; alternative designs that obey the spirit of the present invention by using another management scheme (e.g., the second management scheme of steps 640˜step 670) to receive and clear a card insert interrupt before an original management scheme (e.g., the first management scheme of steps 530˜540) to thereby handle the card insert interrupt and manage the inserted device dynamically via different management schemes (the first management scheme and the second management scheme) according to the specification of the inserted device also fall within the scope of the present invention.

Those skilled in the art will readily observe that numerous modifications and alterations of the device and method may be made while retaining the teachings of the invention.

What is claimed is:

1. A method for dynamically managing a removable device, comprising:
generating a device insertion interrupt to indicate that the removable device has been coupled to a connection interface when detecting an insert event corresponding to the removable device; and
clearing the device insertion interrupt before a processing mechanism corresponding to the connection interface handles the device insertion interrupt; and identifying a specification of the removable device to dynamically manage the removable device according to the specification;
wherein when the specification corresponds to a first specification, a first management scheme is activated to manage the removable device, and when the specification corresponds to a second specification which is different from the first specification, a second management scheme is activated to manage the removable device.

2. The method of claim 1, wherein the connection interface is a secure digital (SD) slot.

3. The method of claim 2, wherein the processing mechanism corresponding to the connection interface is a native SD bus driver built inside an operating system.

4. The method of claim 2, wherein the first specification is an SD card specification, the second specification is a secure digital I/O (SDIO) specification, and the step of identifying the specification of the removable device comprises:
identifying whether the specification of the removable device complies with the SD card specification or the SDIO specification.

5. The method of claim 4, wherein the first management scheme comprises:
managing the removable device by a native disk driver which is loaded through a specified non-native driver, wherein the native disk driver is built inside the operating system.

6. The method of claim 4, wherein the second management scheme comprises:
generating another device insertion interrupt while the removable device is still connected to the connection interface; and
activating the processing mechanism corresponding to the connection interface to handle the device insertion interrupt for enabling a non-native driver which corresponds to the SDIO specification and is not built inside the operating system to manage the removable device.

7. The method of claim 6, wherein the processing mechanism corresponding to the connection interface is a native SD bus driver which is built inside the operating system.

8. A system for dynamically managing a removable device, the system comprising:
a host controller, for generating a device insertion interrupt to indicate that the removable device has been coupled to a connection interface of the host controller when the host controller detects an insert event corresponding to the removable device; and
a host device, coupled to the host controller, for receiving the device insertion interrupt, clearing the device insertion interrupt before a processing mechanism corresponding to the connection interface handles the device insertion interrupt, and identifying a specification of the removable device to thereby dynamically manage the removable device according to the specification;
wherein when the specification of the removable device corresponds to a first specification, the host device activates a first management scheme to manage the removable device, and when the specification of the removable device corresponds to a second specification which is different from the first specification, the host device activates a second management scheme to manage the removable device.

9. The system of claim 8, wherein the connection interface is a secure digital (SD) slot.

10. The system of claim 9, wherein the processing mechanism corresponding to the connection interface is a native SD bus driver built inside an operating system.

11. The system of claim 9, wherein the first specification is an SD card specification, the second specification is a secure digital I/O (SDIO) specification, and the host device is configured to identify whether the specification of the removable device complies with the SD card specification or the SDIO specification.

12. The system of claim 11, wherein the host device manages the removable device by activating the first management scheme for enabling a native disk driver which is loaded through a specified non-native driver, wherein the native disk driver is built inside the operating system to manage the removable device.

13. The system of claim 11, wherein the host device actives the second management scheme to trigger another device insertion interrupt while the removable device is still connected to the connection interface, and the host device activates the processing mechanism corresponding to the connection interface to handle this device insertion interrupt for enabling a non-native driver which corresponds to the SDIO specification and is not built inside the operating system to manage the removable device.

14. The system of claim 13, wherein the processing mechanism corresponding to the connection interface is a native SD bus driver and the native bus driver is built inside the operating system.
